(19) United States
(12) Patent Application Publication
(10) Pub. No.: US 2014/0137054 A1
(43) Pub. Date: May 15, 2014

(54) AUTOMATIC ADJUSTMENT OF FONT ON A VISUAL DISPLAY

(71) Applicants: Saumil Ashvin Gandhi, Sunnyvale, CA (US); Scott Alan Seese, Saratoga, CA (US)

(72) Inventors: Saumil Ashvin Gandhi, Sunnyvale, CA (US); Scott Alan Seese, Saratoga, CA (US)

(73) Assignee: eBay Inc., San Jose, CA (US)

(21) Appl. No.: 13/676,206

(22) Filed: Nov. 14, 2012

(51) Int. Cl. G06F 3/0484

(52) U.S. Cl. CPC G06F 3/0484
USPC 715/865

(57) ABSTRACT

Systems and methods to provide automatic adjustment of font on a visual display are described. In an example system, a vision properties module accesses data stored in a vision record describing one or more vision states of a user of a mobile device. A distance module determines a distance between the user and the mobile device. A display modification module modifies a visual display of the user interface based on a current vision state of the one or more vision states of the user and the distance.

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright eBay, Inc. 2012, All Rights Reserved.

### TECHNICAL FIELD

The present application relates generally to the technical field of visual displays and, in one specific example, to an automatic adjustment of a font in the visual display.

### BACKGROUND

Many people wear glasses or contacts to correct defects in vision. Common defects include myopia (near-sightedness), presbyopia (far-sightedness), and astigmatism. Presbyopia, more specifically, is a condition where the eye exhibits a progressively diminished ability to focus on near objects with age. In optics, the closest point at which an object can be brought into focus by the eye is called the eye's near point. Without correction, the near point is at 3 inches (7 cm) at age 10, to 6 inches (16 cm) at age 40, to 39 inches (1 meter) at age 60. As a result, a 60-year-old must use corrective lenses to read books or magazines at a comfortable distance.

Current bifocals and progressive lenses are static, in that the user has to change their eye position to look through the portion of the lens with the focal power corresponding to the distance of the object. This usually means looking through the top of the lens for distant objects and down through the bottom of the lens for near objects. Adjustable focus eyeglasses have one focal length, but it is variable without having to change where one is looking.

### BRIEF DESCRIPTION OF THE DRAWINGS

Some embodiments are illustrated by way of example and not limitation in the figures of the accompanying drawings in which:

FIGS. 1A and 1B are diagrams depicting example instances of an automatic adjustment of font size.

FIG. 2 is a block diagram of an example system, according to various embodiments.

FIG. 3 is a flowchart illustrating an example method, according to various embodiments.

FIG. 4 is an example auto-adjustment user interface, according to various embodiments.

FIG. 5 is an example user interface for a manual adjustment mode, according to some embodiments.

FIG. 6 is a block diagram illustrating a mobile device, according to an example embodiment.

FIG. 7 is a diagrammatic representation of machine in the example form of a computer system within which a set of instructions, for causing the machine to perform any one or more of the methodologies discussed herein, may be executed.

### DETAILED DESCRIPTION

Example methods and systems to automatically adjust fonts are described. In the following description, for purposes of explanation, numerous specific details are set forth in order to provide a thorough understanding of example embodiments. It will be evident, however, to one skilled in the art that the present invention may be practiced without these specific details.

People use their mobile devices at many different times during the day, sometimes for an instant and for extended periods of time. Users who wear glasses, contact lenses, or other vision correction devices may not wear those devices when using the mobile device. For example, the user may not want to pause to put on reading glasses to use a mobile device or may not have immediate access to their reading glasses. Other users may use a mobile device in bed or in another setting that is not conducive to putting on glasses before performing a task on the mobile device.

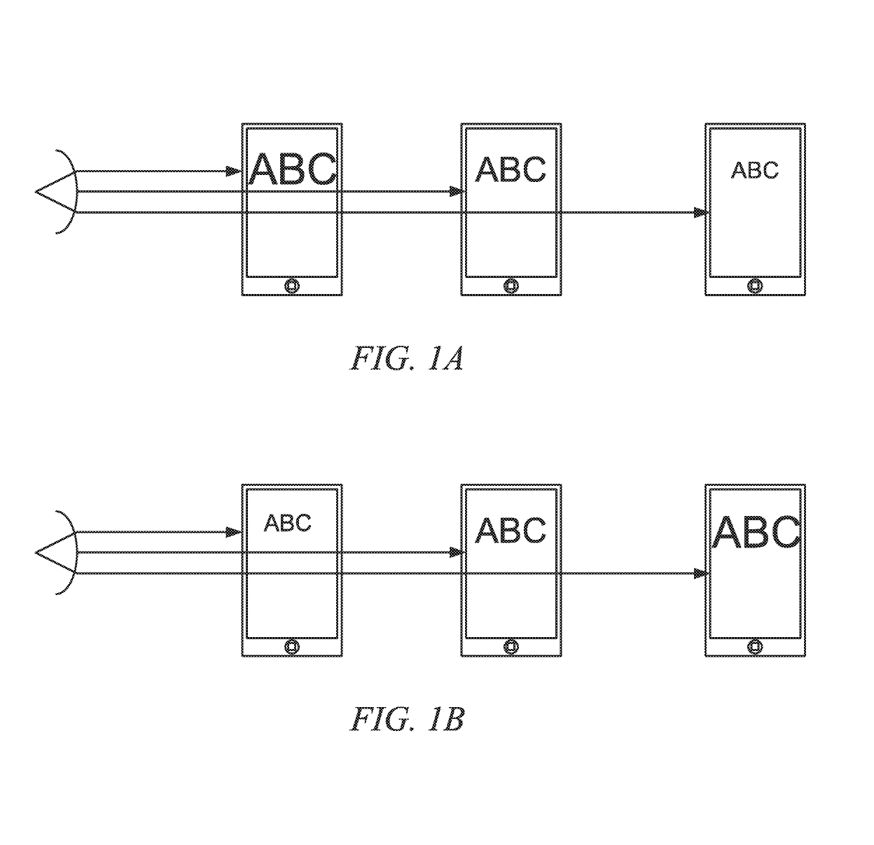

In some embodiments, systems and methods are provided for automatically (e.g., without human interference) adjusting a font in a visual display. The font is adjusted to allow the user to comfortably view the display regardless of whether the user is wearing a particular vision correction device. For example, as depicted in FIG. 1A, a user known to be affected by presbyopia, may set up a mobile device so that a font size in a visual display becomes smaller with increasing distance between the user and the screen of the mobile device. For users who are affected by myopia, the font size may be increased as the mobile device is moved further from the user, as depicted in FIG. 1B. Other adjustments may be made to the font or other images in the visual display to correct for other conditions such as astigmatism.

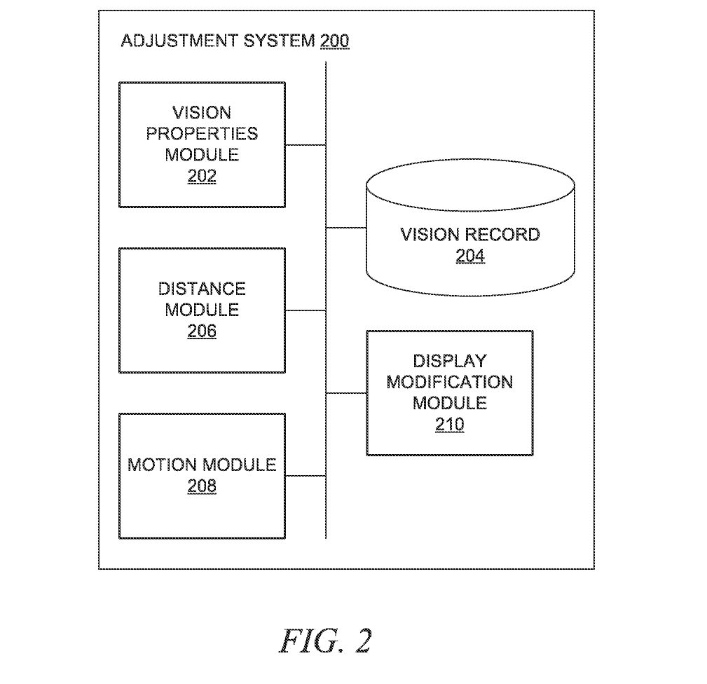

FIG. 2 is a block diagram of an example adjustment system 200 according to some embodiments. The adjustment system 200 may reside in whole or in part on a mobile device (e.g., a smart phone or a tablet). One or more modules of the adjustment system 200 may be implemented or executed using one or more hardware processors. The adjustment system 200 may be part of the operating system (OS) or another software system in the mobile device. The OS may be accessed to provide overall adjustment of the font. In some instances, enhancements may be provided within an application to modify, for example, brightness, saturation, and sharpness.

A vision properties module 202 is configured to receive an initial set of vision properties of the user in a variety of vision states. The vision states of the user may be uncorrected (e.g., wearing no vision correcting devices like glasses or contact lenses) or corrected. A user may have more than one corrected vision state. For example, a user may wear contact lenses in a first corrected vision state and may wear reading glasses with the contact lenses in a second vision corrected state. Similarly, users who wear multi-focal glasses bifocals or trifocals) have more than one corrected vision state. The vision properties may include, for example, the visual acuity of the user (e.g., 20/20) in the various states, a lens power in the various states, a desired level of contrast or brightness of the display, or another property used to measure the display preferences or the vision of the user.

The vision properties module 202 may receive the initial set of vision properties via a graphical user interface on the mobile device or another device. The initial set of vision properties may include a description of the vision states of the user, an eyeglass prescription of the user, whether one corrected vision state of the user affects another corrected vision state (e.g., if the user wears contact lenses that affect the vision state of the user while the user is wearing reading glasses).

In operations, the vision properties module 202 may store the initial set of vision properties in a database or other memory as a vision record 204. Over time, the vision properties module 202 may augment the vision record 204 by adding additional data. The additional data is discussed in greater detail below and may include information collected about the user's viewing habits and preferences.

In operation, the vision properties module 202 may determine the vision state of the user at a particular time. The vision state of the user may be provided by the user via a selection in an alert interface or may be automatically determined. To automatically determine the vision state of the user, the mobile device may capture an image of the user to identify glasses (or other vision correction device) worn by the user. In other embodiments, habits of the user may be recorded. For example, the time of day, amount of motion, and/or ambient light in the user's environment may be determined. Based on the level of ambient light, the user may be more or less likely to be wearing contacts. To illustrate, if a user is interacting with the mobile device at 3 am in the dark, it might be determined that the user was asleep and thus not wearing contact lenses. In contrast, if the user is interacting with the mobile device in bright light and the mobile device has detected being jostled recently, it might be determined that the user was exercising and is likely to be wearing contact lenses.

A distance module 206 is configured to determine example distances between the user's eyes and the display of the mobile device. The distance between the user's eyes and the display is used to make adjustments to the visual display based on the vision state of the user. The distance may be measured in a variety of ways. In some instances, an infrared sensor or a front-facing camera may be used to calculate the distance between the face and the mobile device. For example, a forward-facing camera built-in to the mobile device may be used to capture an image of the user's face during an interaction with the mobile device. Based on the image, the relative size of a facial feature may be measured from which the distance between the user and the display is calculated. To map the relative size of the facial feature to a distance, the user may initially capture a series of self-images at predefined distances. For example, during a set-up process, the user may be directed to capture self-images at distances from extremely close to the user's face to a full arm's length away. The distances may be measured by the user using techniques apparent to those skilled in the art.

During the course of one or more interactions with the user, the motion module 208 is configured to, measure the movement of the mobile device relative to a previous position using an internal accelerometer. For example, in one embodiment, a user may initiate an adjustment of a visual display by placing the mobile device on or near the user's face and slowly moving the device to the desired distance. Any rotational movement of the mobile device may be disregarded in this calculation.

A display modification module 210 is configured to modify the display of the screen based on the vision state of the user and the distance between the user's face and the visual display. For standard vision correction, the properties of the magnifying lens can be replicated by which the font size increases to a predetermined level as the phone moves back and forth. The display modification module 210 may operate as an overlay on top of the actual displayed font to exhibit the properties of a convex or concave lens per the prescription of the user. The overlay may alter the displayed image according to correct for the eye correction.

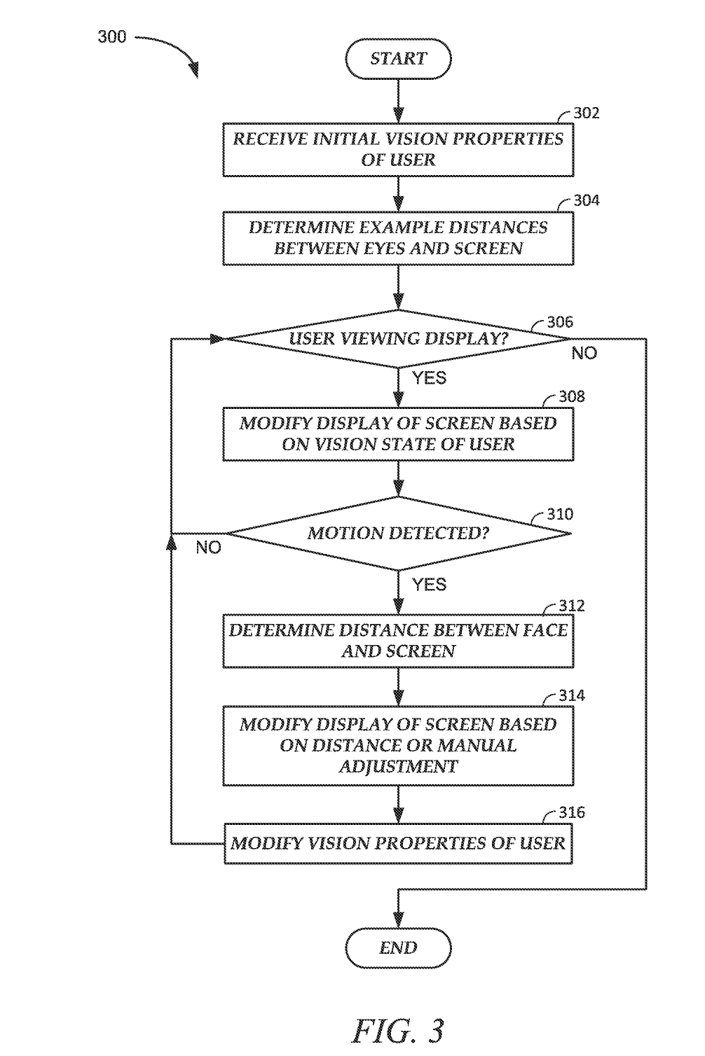

FIG. 3 is a flowchart illustrating an example method 300, according to various embodiments. The method 300 may be performed by the adjustment system 200.

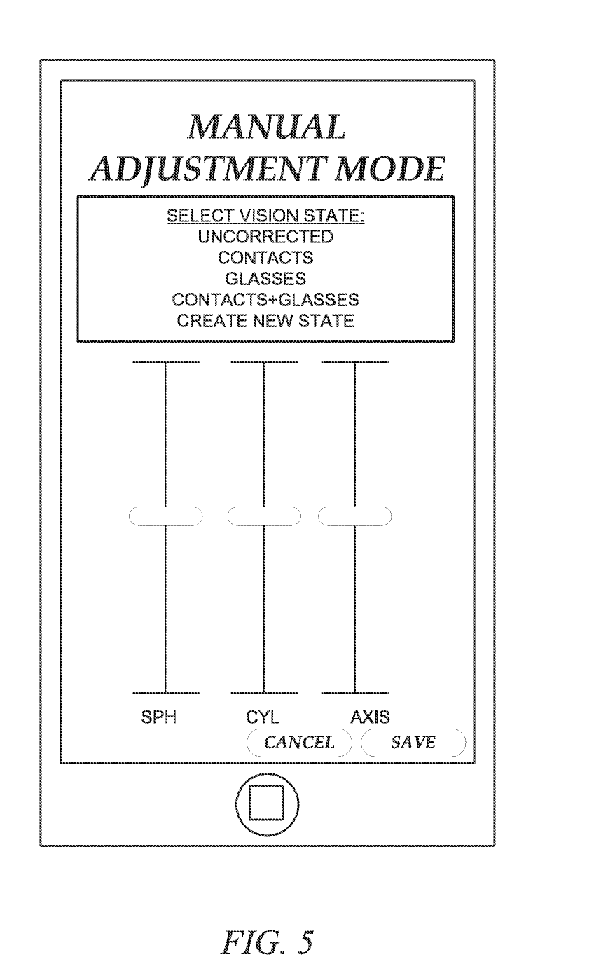

In an operation 302, the initial vision properties of the user are received. The initial vision properties may include one or more vision states. The initial vision properties may be provided by the user or accessed via, for example, an optometrist via a network. In some instances, a user may manually set the initial vision properties using a manual adjustment mode, such as that shown in FIG. 5.

In an operation 304, one or more example distances are determined between the user's eyes or face and the display. These distances may be manually measured and recorded by capturing an image of the user's face at each particular distance.

In an operation 306, a determination is made as to whether the user is viewing the display. The determination may be made, for example, by the motion module 208. If the user is viewing the display, in an operation 308, the vision state of the user is determined and the visual display is modified accordingly. For example, text or images in the display may be enlarged, blurred, or elongated according to data known about the determined vision state of the user.

in an operation 310, a determination is made as to whether a motion has been detected by the mobile device. If a motion has been detected, a feedback loop begins to allow the user to make adjustments to the modified display. These small adjustments may be triggered by a particular movement such as moving the mobile device closer to and further from the user's face in alternating movements.

In an operation 312, a new distance between the face and screen is determined, and, in an operation 314, the display is again modified based on the distance or based on a manual adjustment of the display. In an operation 316, the new modification, vision state, and distance are recorded for later access.

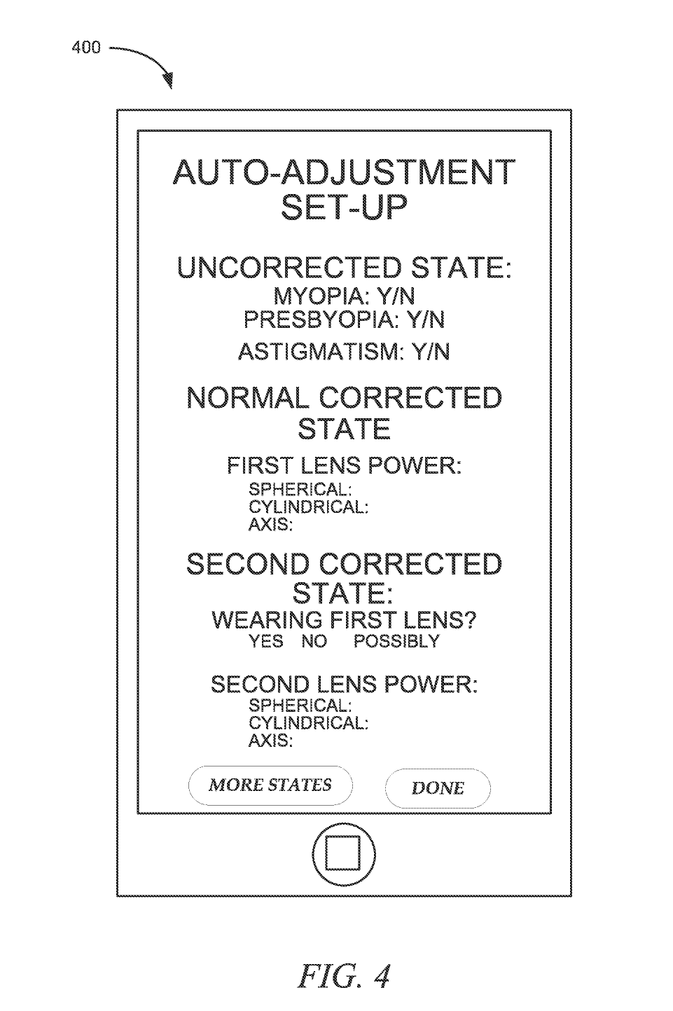

FIG. 4 is an example auto-adjustment user interface 400, according to various embodiments. The auto-adjustment user interface 400 allows a user to define one or more vision states. As depicted, the auto-adjustment interface 400 may receive inputs such as a condition (e.g., myopia or presbyopia), a description of a vision correction device, and an indication of whether a particular vision correction device is used in con junction with another vision correction device. In other instances, the auto-adjustment interface 400 may receive other inputs, such as a vision acuity of the user, inputs describing the vision properties of a second user, or other conditions such as color blindness. In some instances, the user may set other display preferences such as a desired brightness or contrast of the visual display. The user may additionally indicate which elements of the visual display to be modified based on a visual state. For example, a user may wish for only text to be modified or for text and images to be modified.

FIG. 5 is an example user interface 500 for a manual adjustment mode, according to some embodiments. The manual adjustment mode allows a user to manually adjust the modification to the visual display. For example, a user's vision may change suddenly or over time and the modification may need to be altered in order to allow the user to read the visual display. The manual adjustment mode may be defined so as to limit the maximum adjustment that the user can make manually without defining a new vision correction device. As depicted, the user interface 500 includes one or more sliders each used to adjust an aspect of the lens power of the vision correction device of the user. Other interface elements may be used and other properties of the modification may be adjusted. For example, the user interface 500 may allow a user to adjust a color balance of the visual display to compensate for color-blindness.

### Example Mobile Device

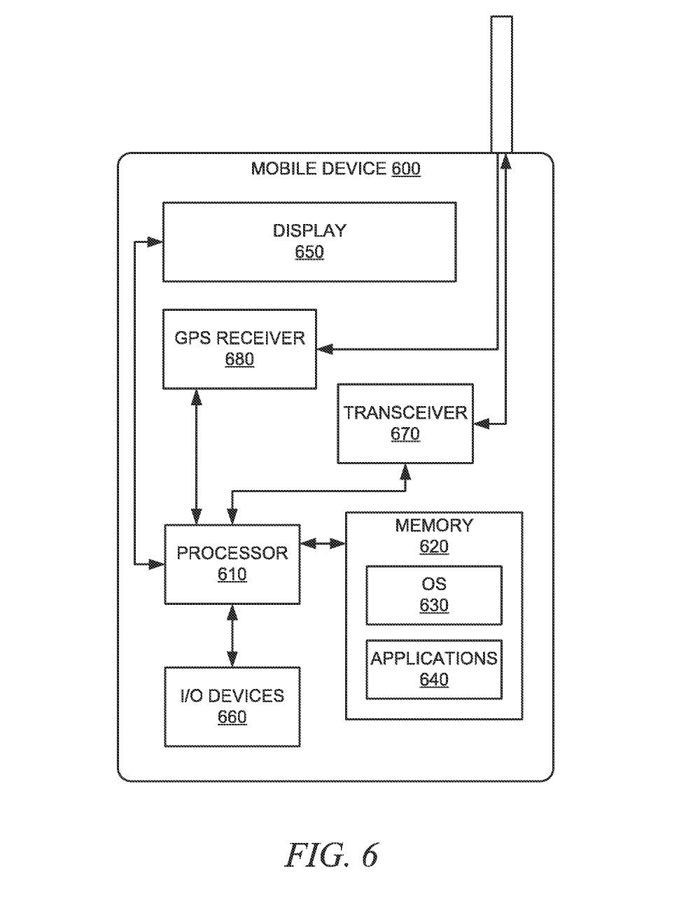

FIG. 6 is a block diagram illustrating a mobile device 600, according to an example embodiment. The mobile device 600 may include a processor 610. The processor 610 may be any of a variety of different types of commercially available processors suitable for mobile devices (for example, an XScale architecture microprocessor, a Microprocessor without Interlocked Pipeline Stages (MIPS) architecture processor, or another type of processor). A memory 620, such as a Random Access Memory (RAM), a Flash memory, or other type of memory, is typically accessible to the processor. The memory 620 may be adapted to store an operating system (OS) 630, as well as application programs 640, such as a mobile location enabled application that may provide LBSs to a user. The processor 610 may be coupled, either directly or via appropriate intermediary hardware, to a display 650 and to one or more input/output (I/O) devices 660, such as a keypad, a touch panel sensor, a microphone, a forward-facing digital camera to capture an image of the user of the mobile device 600, an accelerometer, and the like. Similarly, in some embodiments, the processor 610 may be coupled to a transceiver 670 that interfaces with an antenna 690. The transceiver 670 may be configured to both transmit and receive cellular network signals, wireless data signals, or other types of signals via the antenna 690, depending on the nature of the mobile device 600. In this manner, a connection with a communication network may be established. Further, in some configurations, a GPS receiver 680 may also make use of the antenna 690 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e,g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

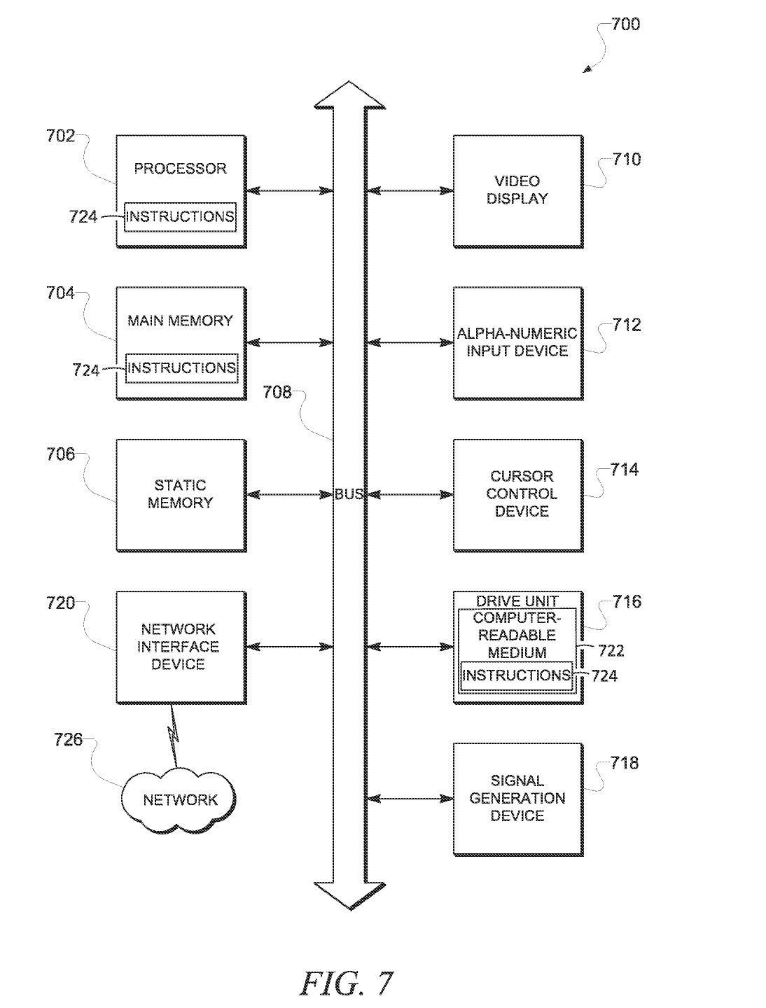

FIG. 7 is a block diagram of machine in the example form of a computer system 700 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard or a touch-sensitive display screen, a user interface (UI) navigation device 714 (e.g., a mouse), a disk drive unit 716, a signal generation device 718 (e.g., a speaker) and a network interface device 720.

### Machine-Readable Medium

The disk drive unit 716 includes a machine-readable medium 722 on which is stored one or more sets of instructions and data structures (e.g., software) 724 embodying or utilized by any one or more of the methodologies or functions described herein. The instructions 724 may also reside, completely or at least partially, within the main memory 704 and/or within the processor 702 during execution thereof by the computer system 700, the main memory 704 and the processor 702 also constituting machine-readable media.

While the machine-readable medium 722 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 724 may further be transmitted or received over a communications network 726 using a transmission medium. The instructions 724 may be transmitted using the network interface device 720 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system comprising:
a vision properties module to access data stored in a vision record describing one or more vision states of a user of a mobile device;
a distance module to determine a distance between the user and the mobile device; and
a display modification module to, using one or more processors, modify a visual display of the user interface based on a current vision state of the one or more vision states of the user and the distance.

2. The system of claim 1, wherein the vision state of the user is based on an eyeglass prescription prescribed to the user.

3. The system of claim 1, wherein the current vision state of the user is affected by presbyopia.

4. The system of claim 1, wherein the current vision state of the user is affected by myopia.

5. The system of claim 1, wherein the vision properties module is further to determine the current vision state.

6. The system of claim 1, wherein the vision properties module is further to augment the vision record based on the user's viewing habits or preferences.

7. The system of claim 1, wherein the vision properties module is further to provide an alert interface to receive a selection of the current vision state.

8. The system of claim 1, wherein the vision properties module is further to determine the current vision state by identifying glasses worn by the user.

9. The system of claim 1, wherein the vision properties module is further to determine the current vision state based on habits of the user.

10. The system of claim 1, wherein the distance module is to determine the distance using an infrared sensor of the mobile device.

11. The system of claim 1, wherein the distance module is to determine the distance based on a relative size of a facial feature from an image captured by a camera of the mobile device.

12. The system of claim 1, further comprising a motion module to measure movement of the mobile device relative to a previous position using an internal accelerometer.

13. The system of claim 1, wherein the display modification module is to modify the visual display of the user interface by increasing a font size to a predetermined level.

14. The system of claim 13, wherein the predetermined level is based in part on movement of the mobile device.

15. The system of claim 1, wherein the display modification module is to modify the visual display of the user interface by exhibiting the properties of a lens.

16. The system of claim 1, wherein the lens is concave.

17. The system of claim 1, wherein the lens is convex.

18. The system of claim 1, wherein the display modification module is to modify the visual display of the user interface based on color-blindness of the user.

19. A method comprising:
accessing data stored in a vision record describing one or more vision states of a user of a mobile device;
determining a distance between the user and the mobile device; and
using one or more processors, modifying a visual display of the user interface based on a current vision state of the one or more vision states of the user and the distance.

20. A non-transitory computer-readable medium having instructions embodied thereon, the instructions executable by one or more processors to perform a method comprising:
accessing data stored in a vision record describing one or more vision states of a user of a mobile device;
determining a distance between the user and the mobile device; and
modifying a visual display of the user interface based on a current vision state of the one or more vision states of the user and the distance.
